(19) United States
(12) Patent Application Publication
(10) Pub. No.: US 2015/0363296 A1
(43) Pub. Date: Dec. 17, 2015

(54) FUNCTION TEST APPARATUS BASED ON UNIT TEST CASES REUSING AND FUNCTION TEST METHOD THEREOF

(71) Applicant: KYUNGPOOK NATIONAL UNIVERSITY INDUSTRY-ACADEMIC COOPERATION FOUNDATION, Daegu (KR)

(72) Inventors: Woo Jin LEE, Suseong-gu, Daegu (KR); Young Shul SHIN, Dalseo-gu, Daegu (KR)

(21) Appl. No.: 14/123,297

(22) PCT Filed: Dec. 18, 2012
(86) PCT No.: PCT/KR2012/011087

§ 371 Date: Dec. 2, 2013

(30) Foreign Application Priority Data
Dec. 5, 2012 (KR) 10-2012-0140573

(51) Int. Cl. G06F 11/36

(52) U.S. Cl. CPC G06F 11/3684; G06F 11/3604

(57) ABSTRACT

There is provided a function test apparatus based on unit test cases reusing and a function test method thereof. The function test apparatus related to the present disclosure is constructed with a Storage Portion, storing a unit test case for each function into a hierarchical constitution; a Selection Portion of unit test case, when a Test Object Function is provided, in order to abstract an internal constitution of a callee function activated by the Test Object Function, selectively reusing a unit test case of the callee function; a Generator of test case, generating at least one test case in order for all the unit test cases selected by the Selection Portion of test case to be performed; and a Performance Portion of test case, testing the Test Object Function by performing the test case. According to the configuration herein, a test for function may be conducted without analyzing the internal constitution of software function at an integral testing motion and a test of which a Test coverage is high may be conducted to the Test Object Function. Therefore, an advantage of high reliability for the test result is obtained.

### TECHNICAL FIELD

The present disclosure relates to a Function Test Apparatus, and more specifically, relates to a Function Test Apparatus based on Unit Test Cases Reusing and a Function Test Method thereof, characterized of examining an interaction between functions to see if it performed correctly by selectively reusing a unit test case of a callee function from a caller function, at an integration testing phase.

### BACKGROUND ART

In order to test an apparatus or a system, test object software has to be performed according to test case.

However, the recent software become gradually complicated according as its functionality increase. Due to the complicated operation, designs for a test execution environment and a test case cost a lot of time and expenses. Also, the software complicatedly configured may cause a lot of errors at a test operation.

In this regard, necessity for a software test is arising in order to minimize a development period or an increase of costs along with resolving various errors, and to develop software featuring productivity and reliability.

Importance of a software test leads to an expectation for a high quality of an Embeded system. Specifically, a system of an aircraft or a medical device requiring an extremely high reliability is characterized in that process for examining software and proving validity takes up more than half of the whole project development resources. Generating a test case in the series of the operations for testing is recognized as an important operation to determine a quality and efficiency of a test.

In the meantime, there is necessity for examining an interaction between functions to perform a test at an apparatus or a system. This is because the apparatus or system is composed of several functions and the operation of the apparatus or system is generally controlled through the interaction between functions. Also, the errors of the software usually occur during performing the interaction between functions, therefore, a test of the interaction between functions should be implemented.

Conventionally, a lot of methods were suggested in order to verify whether or not interaction between functions performs normally.

An examination method of detecting an error in interaction between functions, by testing a caller function activating a plurality of callee functions, can be exemplified.

Hereat, a prerequisite is required for analyzing all the internal constitutions of the callee functions in order to test the caller function. A test of the interaction between functions may be easily performed, provided that the internal constitution of the callee function is easily analyzed (i.e., the prerequisite). However, the internal constitution of the caller function is formed very complicatedly since the caller function includes the plurality of the callee functions. This means impossibility of analyzing the internal constitution of the caller function.

Therefore, the method is selectively used only if the information amount of the callee function is extremely small enough to analyze all the internal constitutions of the callee function. That is, it is a difficult method to substantially apply to a function test considering the development period or costs, under the recent environment condition that the software is being complicatedly manufactured.

When storing a test case of a specific function and retesting the same function, another use method of reaccessing the stored test case can be exemplified.

However, there is a problem that the method can only be applied to the same function, and it cannot exploit the stored test case, when testing other functions.

### DISCLOSURE

### Technical Problem

Therefore, the objective of the present disclosure is to solve the described problems above, and to test to see if the interaction between functions is normally performed by selectively reusing a unit test case used in the callee function and thereby generating and using a test case, when generating a test case of caller function at the integration testing phase.

The other objective of the present disclosure is to make it possible to test for function without analyzing the internal constitution of the callee function activated by the caller function when performing test for the interaction between functions.

The other objective of the present disclosure is to classify and store the unit test case of functions into a hierarchical constitution, according to a Test coverage, and thereby to improve applicability of the unit test case.

### Technical Solution

According to the characteristic of the present disclosure for accomplishing the objects, a function test apparatus based on unit test cases reusing comprising a Storage Portion, storing a unit test case for each function into a hierarchical constitution; a Selection Portion of unit test case, when a Test Object Function is provided in order to abstract an internal constitution of a callee function activated by the Test Object Function, selectively reusing the unit test case of the callee function; a Generator of test case, generating at least one test case in order for all the unit test cases selected by the Selection Portion of test case to be performed; and a Performance Portion of test case, testing the Test Object Function by performing the test case is provided.

The unit test case is a unit test case which passed a unit testing for the callee function before it is integrated with the Test Object Function.

An abstract view of the internal constitution is characterized in that a level of abstract is determined by an integration testing policy.

According to another characteristic of the present disclosure, a function test apparatus based on unit test cases reusing comprising a Generator, generating a test case by reusing the unit test case of at least one callee function activated by the Test Object Function; and a Tester, testing the Test Object Function, is provided.

When the unit test case is reused, the internal constitution of the callee function is abstracted according to the integration testing policy.

The unit test case, reused when the test case is generated is a unit test case used in the unit testing of the callee function, and the unit test case has a Test coverage providing a specific coverage.

The Test coverage is configured to have a hierarchical inclusive relationship.

According to another characteristic of the present disclosure, a function test method based on unit test cases reusing comprising the operations of generating a test request for a Test Object Function; selecting a unit test case obtained by at least one callee function activated by the Test Object Function upon the test request; generating a test case by reusing the selected unit test case; and performing the generated test case, is provided.

Before the operation of generating a request, the operation of storing a unit test case for the callee function into a hierarchical constitution is further comprised.

The internal constitution of the callee function is abstracted when the unit test case is selected at the operation of selecting the unit test case.

The operation of generating test case is characterized of generating at least one or more test cases.

The operation of performing test case is characterized of performing a test for the Test Object Function by using a test case having a highest Test coverage from the at least one or more test cases.

### Effect

A function test apparatus based on unit test cases reusing and a function test method thereof according to the present disclosure have effects as follows:

At first, a test for function may be performed without analyzing the internal constitution of the software function at the integration testing phase.

And, high reliability can be secured about the test result by performing a test having a high Test coverage for the Test Object Function.

Further, the effect of reducing the cost of integral testing may be expected since a unit test case in which various functions passed the unit testing operation is reused.

### BRIEF DESCRIPTION OF THE DRAWINGS

FIG. 1 illustrates a block constitutional view representing a function test apparatus based on a unit test case reusing according to an exemplary embodiment of the preset disclosure;

FIG. 2 illustrates a plan view of an example that a unit test case is stored into a hierarchical constitution according to the present disclosure;

FIG. 3 illustrates a flow view representing a method of producing a test case according to an exemplary embodiment of the present disclosure;

FIG. 4 illustrates an example view of a condition that a unit test case is reused in FIG. 3; and

FIG. 5 illustrates a graph representing a measured result of function test according to the present disclosure.

### DETAILED DESCRIPTION

Hereinafter, embodiments of a function test apparatus based on unit test cases reusing and a function test method thereof according to the present disclosure will be described in detail by referring to the following attached drawings.

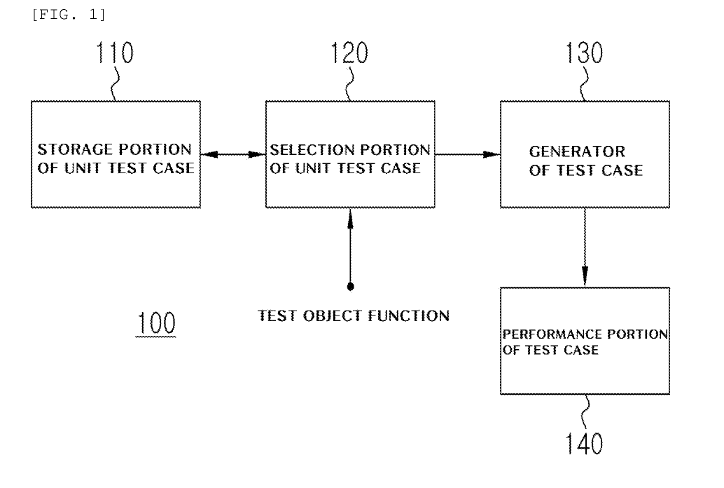

FIG. 1 illustrates a block constitutional view representing a function test apparatus based on a unit test case reusing according to an exemplary embodiment of the preset disclosure.

The function test apparatus based on unit test cases reusing of the present disclosure (hereinafter, “The function test apparatus”) is configured to:

generate a test case by reusing a unit test case obtained by a plurality of the callee functions activated by the caller function at the integration testing phase,

perform all unit test cases included in the test case, and

test if a caller function performs a normal interaction with a callee function.

The constitution of function test apparatus therefor will be described.

A Storage Portion of unit test case 110, storing a unit test case of a callee function is comprised. The Storage Portion of unit test case 110 is configured to store the test case used in the unit testing by processing into a hierarchical constitution. This is for enhancing management efficiency about the unit test case and for providing usability.

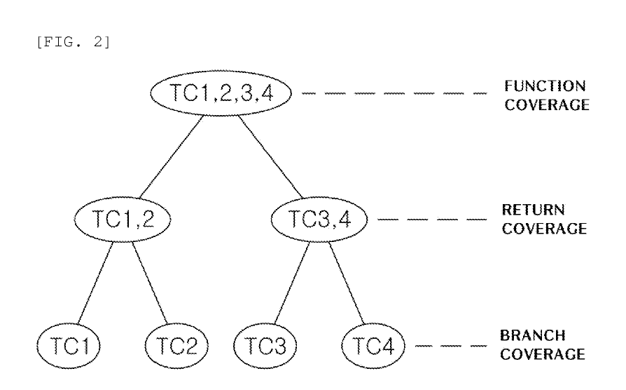

An example of storing a unit test case into a hierarchical constitution is illustrated in FIG. 2. As illustrated in FIG. 2, a Function coverage, a Return coverage and a Branch coverage are included. As an example, the Branch coverage is comprised of unit test cases 1 to 4 respectively, the Return coverage is comprised of unit test cases 1 and 2 and unit test cases 3 and 4, and the Function coverage is comprised of all the unit test cases of the each function.

As described above, the unit test cases of each function have a Test coverage which satisfies them. Also, intervals of each coverage are configured to have hierarchical inclusive relationship. In other words, each unit test case is hierarchically stored for reusing according to arbitrary Test coverage. Such coverage will be used for designing a test in order to accomplish the corresponding coverage and for generating a test case. A hierarchical constitution may be provided as a Statement coverage or a Condition coverage, etc., are further added, other than the coverage.

A Selection Portion of test case 120 is configured to select a unit test case of corresponding functions from a Storage Portion of unit test case 110 in order to examine the Test Object Function, according to the integration testing policy. Selecting the unit test case is performed within the scope in which the standard of Test coverage is satisfied. And, the internal constitution of the corresponding function may be abstracted when the unit test case is selected. For instance, it would be possible to test the caller function without analyzing the internal constitution of the callee function, if one caller function reuses the unit test cases of at least two or more callee functions. In the meantime, as for the abstract, the level of abstract is determined by the integration testing policy.

A Generator of test case 130, generating a test case in order to carry out all the unit test cases selected by the Selection Portion of test case 120 is comprised. The test case may be at least one or more. That is, the test case may be generated for the all software modules to be tested.

When the test case is generated, a Performance Portion of test case 140 is configured to test the Test Object Function by using the generation. The Performance Portion of test case 140 is to perform a test according to the generated test case, hereat, abstract information may be used only without analyzing the internal constitution of other functions included in the Test Object Function.

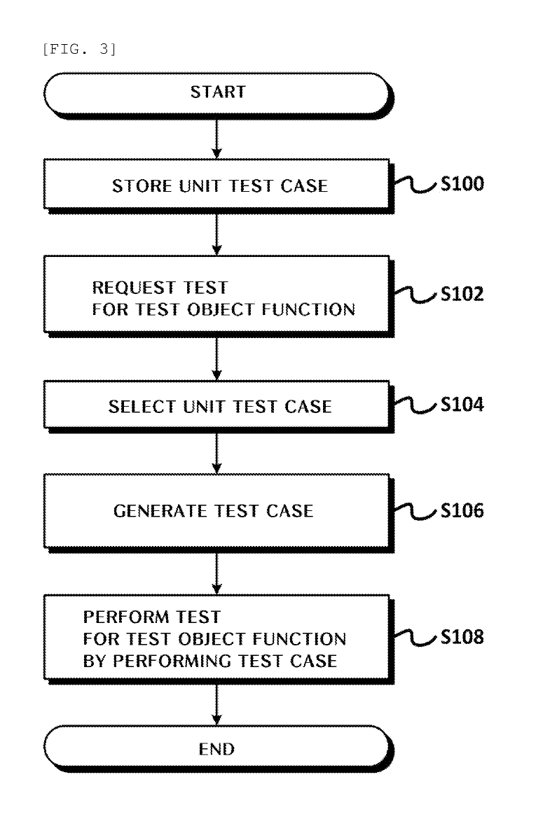

Next, a method of producing test case according to the present disclosure is described by referring to FIG. 3.

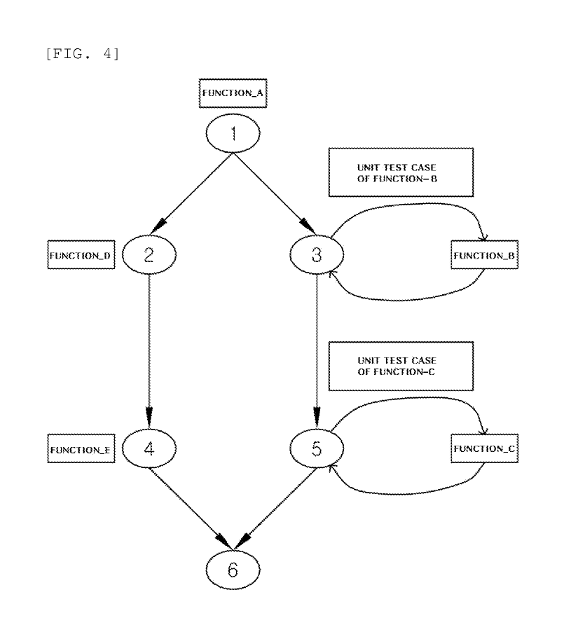

At first, the Test Object Function should be provided. For an example of the Test Object Function, FIG. 4 would be referenced.

As illustrated in FIG. 4, function A, function B, function C, function D, and function E are provided and a Test Object Function is assumed as function A among them. In this case, the function A is a caller function activating functions B to E; the functions B to E become callee functions. The function D becomes a function activating function E, provided that the Test Object Function is function D. Therefore, a test case including functions B and C, and a test case including functions D and E may be generated when testing the Test Object Function A.

In the embodiments, testing function A including functions B and C is described.

And, the functions B to E have each unit test case respectively. Hereat, the unit test cases of the functions B to E become unit tests which already passed a unit testing, prior to being integrated with the function A. The unit test cases for the respective functions are being stored in a Storage Portion of unit test case 110 (s100).

A request for test to the function A is generated under the condition that the unit test case is stored as such (s102).

When a request for test to the function A is generated, the Selection Portion of test case 120 should select the unit test case of the callee function according to the integration testing policy, in order to generate the test case (s104). In return, the Selection Portion of test case 120 selects the unit test cases of the functions B and C which already passed the unit testing, to be reused. Then, the internal constitutions of the functions B and C may be abstracted. That is, this is because the unit test cases of the functions B and C already reflect their own constitutions of the functions B and C. Accordingly, a test may be performed without analyzing the all internal constitutions of the functions B and C activated by the function A which is an object for a test.

When a unit test case for function is selected, a Generator of test case 130 generates a test case by reusing the unit test cases of the functions B and C (s106). A test case interlocking the unit test cases of the functions D and E is generated, only provided that the Test Object Function A tests an interaction between the functions D and E. That is, the test cases may be generated separately according to the Test Object Function. In addition, one or more test cases for one Test Object Function may be generated. Hereat, Test coverage of test case is differently provided respectively.

The test case generated as above is delivered to a Performance Portion of test case 140. The Performance Portion of test case 140 performs the generated test case (s108). As a result of the performance, it may be possible to test if the function A normally performs the interaction between the functions B and C. That is, errors generated in the interaction between the functions may be detected.

At this time, a Performance Portion of test case 140 may perform a test for the Test Object Function by using a test case having a highest Test coverage from one or more test cases.

As described so far, in the embodiments of the present disclosure, the caller function is configured to generate a test case by reusing a unit test case provided by the callee function, and the examination for the errors made from the interaction between the functions is implemented therethrough, at the integration testing phase.

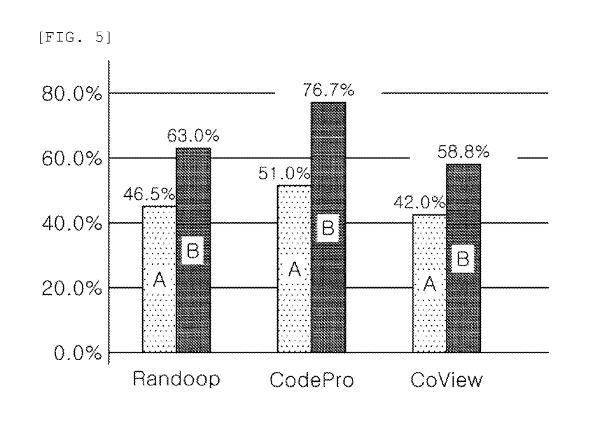

In the meantime, improvement of a capability of Test coverage may be seen by the measurement result when applying the said embodiments of the present disclosure. That is, as for a Randoop method, a CodePro method, and a CoView method, it is observed that a rate of case of reusing a unit test case is improved about 16% to 25% than that of case of not reusing a unit test case. The measured result is illustrated in FIG. 5. FIG. 5 illustrates ‘A’ that represents a condition in which a test method of the present embodiment is not applied and ‘B’ that represents a condition in which a test method of the present embodiment is applied.

And, the present embodiments are not limited in performing a test for specific software; they are capable of performing a test by applying to most of the general software including the Embedded software.

So far, explanations were represented by referring to the illustrated embodiments of the present disclosure; however, these are merely examples. Further, a skilled person in the art may easily understand that other variously altered, changed, and equivalent embodiments regarding the present ones can be feasible within the scope of the substance of the present disclosure. Therefore, a true technical range to be protected for the present disclosure should be determined by the technical thought of the scope of the attached claims.

### DESCRIPTION OF THE MARKS

110: Storage Portion of unit test case
120: Selection Portion of unit test case
130: Generator of test case
140: Performance Portion of test case

What is claimed is:

1. A function test apparatus based on unit test cases reusing, comprising:
a Storage Portion, storing a unit test case for each function into a hierarchical constitution;
a Selection Portion of unit test case, when a Test Object Function is provided, in order to abstract an internal constitution of a callee function activated by the Test Object Function, selectively reusing a unit test case of the callee function;
a Generator of test case, generating at least one test case in order for all the unit test cases selected by the Selection Portion of test case to be performed; and
a Performance Portion of test case, testing the Test Object Function by performing the test case.

2. The function test apparatus based on unit test cases reusing according to claim 1,
wherein the unit test case is a unit test case which passed a unit testing for the callee function, prior to being integrated with the Test Object Function.

3. The function test apparatus based on unit test cases reusing according to claim 1,
wherein an abstract view of the internal constitution is characterized in that a level of abstract is determined by an integration testing policy.

4. A function test apparatus based on unit test cases reusing, comprising:
a Generator, generating a test case by reusing a unit test case of at least one callee function activated by the Test Object Function; and
a Tester, testing the Test Object Function.

5. The function test apparatus based on unit test cases reusing according to claim 4,
wherein the internal constitution of the callee function is abstracted by the integration testing policy, when the unit test case is reused.

6. The function test apparatus based on unit test cases reusing according to claim 4,
wherein the unit test case, reused during generating the test case is a unit test case used in the unit testing of the callee function, and
wherein the unit test case has a Test coverage providing a specific coverage.

7. The function test apparatus based on unit test cases reusing according to claim 6,
wherein the Test coverage is configured to have a hierarchical inclusive relationship.

8. A function test method based on unit test cases reusing, comprising the operations of:
generating a test request for a Test Object Function;
selecting a unit test case obtained by at least one callee function activated by the Test Object Function, upon the test request;
generating a test case by reusing the selected unit test case; and
performing the generated test case.

9. The function test method based on unit test cases reusing according to claim 8, further comprising the operation of:
storing a unit test case for the callee function into a hierarchical constitution, prior to the operation of generating a request.

10. The function test method based on unit test cases reusing according to claim 8,
wherein an internal constitution of the callee function is abstracted, when a unit test case is selected at the operation of selecting a unit test case.

11. The function test method based on unit test cases reusing according to claim 8,
wherein the operation of generating a test case is characterized of generating at least one or more test cases.

12. The function test method based on unit test cases reusing according to claim 11,
wherein the operation of performing a test case is characterized of performing a test for the Test Object Function by using a test case having a highest Test coverage from the at least one or more test cases.
